(19) United States
(12) Patent Application Publication
(10) Pub. No.: US 2026/0295316 A1
(43) Pub. Date: Oct. 1, 2026

(54) DELIVERING FIREFIGHTING-FOAM MATERIAL

(71) Applicant: Howe & Howe Inc., Waterboro, ME (US)

(72) Inventors: Timothy Merlin Foley, Lyman, ME (US); Michael J. Zagorianakos, Buxton, ME (US)

(21) Appl. No.: 19/095,692

(22) Filed: Mar. 31, 2025

(51) Int. Cl. A62C 25/00; A62C 27/00; A62C 37/36; A62C 99/00

(52) U.S. Cl. CPC A62C 25/00; A62C 27/00; A62C 37/04; A62C 99/0036

(57) ABSTRACT

Techniques are directed to providing a firefighting-foam delivery system. The firefighting-foam delivery system includes a foam-material source constructed and arranged to contain firefighting-foam material. The firefighting-foam delivery system further includes a compressed-air source constructed and arranged to provide compressed air. The firefighting-foam delivery system further includes a control assembly coupled with the foam-material source and the compressed-air source. The control assembly is constructed and arranged to deliver the firefighting-foam material from the foam-material source under pressure from the compressed air when the control assembly is in a first configuration, and deliver the firefighting-foam material from the foam-material source not under pressure from the compressed air when the control assembly is in a second configuration.

### BACKGROUND

A firefighting vehicle which is robotically driven may be used in dangerous situations rather than risk human injury/life. For example, the nozzle end of a firehose may be attached to such a vehicle to enable the vehicle to apply water to an unsafe structure such as a burning object. Additionally, another hose from a foam-supply truck may be concurrently connected to the vehicle to enable the vehicle to apply foam to the unsafe structure along with the water.

During operation, a human operator remotely controls the vehicle from a safe distance. In particular, while one or more hoses is/are connected to the vehicle, the human operator may robotically drive the vehicle within spraying distance of the unsafe structure and deliver spray from the nozzle onto the unsafe structure.

### SUMMARY

Improved techniques are directed to a firefighting-foam delivery system that can switch between different configurations for delivering firefighting-foam material. In one configuration, the firefighting-foam delivery system injects compressed air into a foam-material source to discharge firefighting-foam material from the foam-material source. In another configuration, the firefighting-foam delivery system blocks the compressed air from entering the foam-material source and instead enables the firefighting-foam material to be drawn from foam-material source, e.g., by siphoning. By providing different configurations, the firefighting-foam delivery system provides compatibility with a variety of different equipment and firefighting-foam materials.

One embodiment is directed to a firefighting-foam delivery system. The firefighting-foam delivery system includes a foam-material source constructed and arranged to contain firefighting-foam material. The firefighting-foam delivery system further includes a compressed-air source constructed and arranged to provide compressed air. The firefighting-foam delivery system still further includes a control assembly coupled with the foam-material source and the compressed-air source. The control assembly is constructed and arranged to deliver the firefighting-foam material from the foam-material source under pressure from the compressed air when the control assembly is in a first configuration. The control assembly is further constructed and arranged to deliver the firefighting-foam material from the foam-material source not under pressure from the compressed air when the control assembly is in a second configuration.

Another embodiment is directed to a vehicular robot. The vehicular robot includes a vehicle body. The vehicular robot further includes a set of ground-engaging members coupled with the vehicle body. The vehicular robot still further includes a firefighting-foam delivery system, such as the firefighting-foam delivery system described above.

Yet another embodiment is directed to a method of providing firefighting-foam material. The method includes provisioning a firefighting-foam delivery system, such as the firefighting-foam delivery system as described above, with the firefighting-foam material. The method further includes delivering the firefighting-foam material from the foam-material source under pressure from the compressed air when the control assembly is in a first configuration. The method still further includes delivering the firefighting-foam material from the foam-material source not under pressure from the compressed air when the control assembly is in a second configuration.

In some arrangements, the foam-material source includes a set of containers constructed and arranged to hold the firefighting-foam material. Additionally, the firefighting-foam delivery system further includes mounting hardware constructed and arranged to couple the set of containers to a firefighting vehicle.

In some arrangements, the control assembly is further constructed and arranged to selectively permit the compressed air provided by the compressed-air source to enter the set of containers to pressurize the firefighting-foam material held within the set of containers.

In some arrangements, the foam-material source further includes a set of vents constructed and arranged to block air within the set of containers from exiting the set of containers when the control assembly is in the first configuration, and channel air that is initially outside the firefighting-foam delivery system into the set of containers when the control assembly is in the second configuration.

In some arrangements, the control assembly further includes a connector coupled between the set of containers and equipment mounted to the firefighting vehicle. The equipment mounted to the firefighting vehicle has a first inlet port and a second inlet port. Further, the connector is constructed and arranged to direct the firefighting-foam material to the first inlet port when the control assembly is in the first configuration, and direct the firefighting-foam material to the second inlet port in place of the first inlet port when the control assembly is in the second configuration.

In some arrangements, the set of containers includes a container having:
(i) a bottom that includes a first end portion and a second end portion opposite the first end portion; and
(ii) an outlet port disposed at the second end portion.

Additionally, the mounting hardware is further constructed and arranged to position the first end portion higher than the second end portion to urge firefighting-foam material within the container towards the outlet port.

In some arrangements, the mounting hardware is further constructed and arranged to mount the second end portion closer to an aft end of the firefighting vehicle than the first end portion.

In some arrangements, the set of containers includes a first container and a second container. Additionally, the firefighting-foam delivery system further comprises a rack spanning the first container and the second container, the rack being constructed and arranged to support the compressed-air source.

In some arrangements, the compressed-air source includes a set of air tanks constructed and arranged to contain the compressed air.

In some arrangements, the vehicular robot further includes a compressed-air foam (CAF) nozzle assembly constructed and arranged to receive the firefighting-foam material from the firefighting-foam delivery system when the control assembly is in the first configuration. Additionally, the vehicular robot still further includes a monitor assembly constructed and arranged to receive the firefighting-foam material from the firefighting-foam delivery system when the control assembly is in the second configuration.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a perspective view of a robotic foam delivery system in accordance with certain embodiments.

FIG. 2 is another perspective view of the robotic foam delivery system in accordance with certain embodiments.

FIG. 3 is a side view of the robotic foam delivery system in accordance with certain embodiments.

FIG. 4 is a partial view of the robotic foam delivery system in accordance with certain embodiments.

FIG. 5 is another partial view of the robotic foam delivery system in accordance with certain embodiments.

FIG. 6 is another partial view of the robotic foam delivery system in accordance with certain embodiments.

FIG. 7 is a top-down view of the robotic foam delivery system in accordance with certain embodiments.

FIG. 8 is another top-down view of the robotic foam delivery system in accordance with certain embodiments.

FIG. 9 is another perspective view of the robotic foam delivery system in accordance with certain embodiments.

FIG. 10 is another perspective view of the robotic foam delivery system in accordance with certain embodiments.

FIG. 11 is a perspective view of a fluid tank assembly in accordance with certain embodiments.

FIG. 12 is a block diagram showing various features of the robotic foam delivery system in accordance with certain embodiments.

FIG. 13 is a flowchart of a procedure for providing foam concentrate in accordance with certain embodiments.

### DETAILED DESCRIPTION

An improved technique is directed to a firefighting-foam delivery system that can switch between different configurations for delivering firefighting-foam material. In one configuration, the firefighting-foam delivery system feeds compressed air from a compressed-air source into a foam-material source to discharge firefighting-foam material from the foam-material source. In another configuration, the firefighting-foam delivery system blocks the compressed air from entering the foam-material source and instead enables the firefighting-foam material to be drawn from foam-material source, e.g., by siphoning. By providing different configurations, the firefighting-foam delivery system may deliver the foam material in different ways, increasing compatibility with a variety of different equipment and/or firefighting-foam materials.

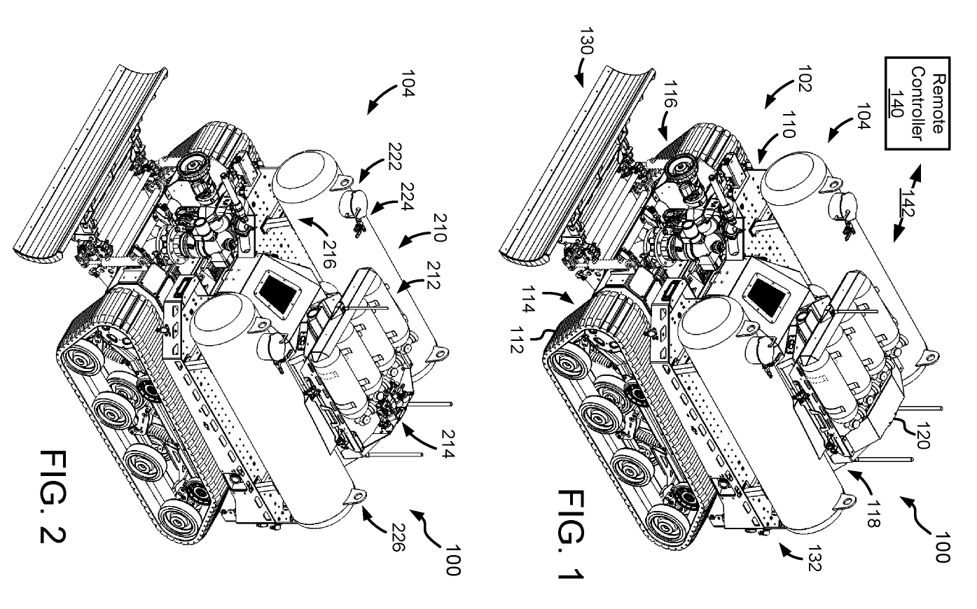

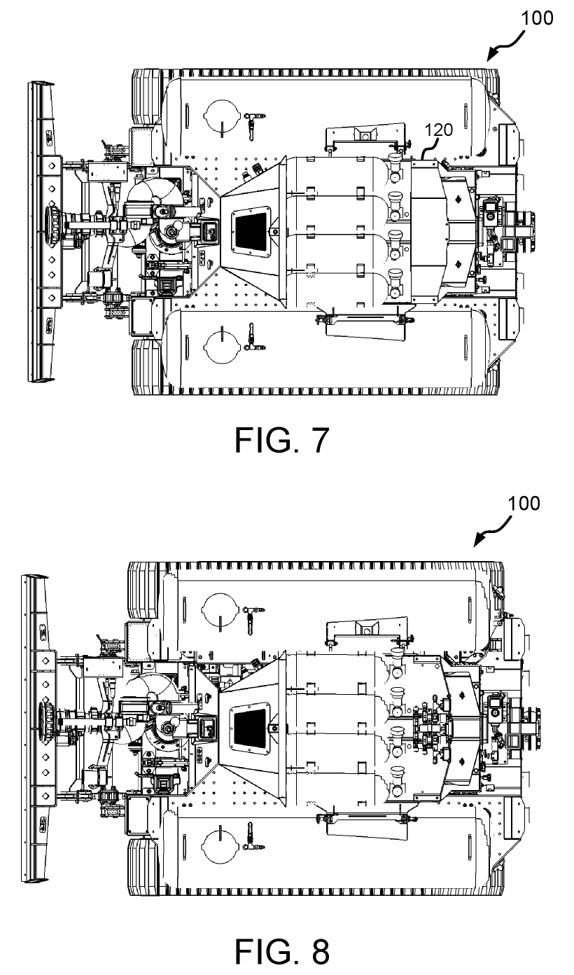

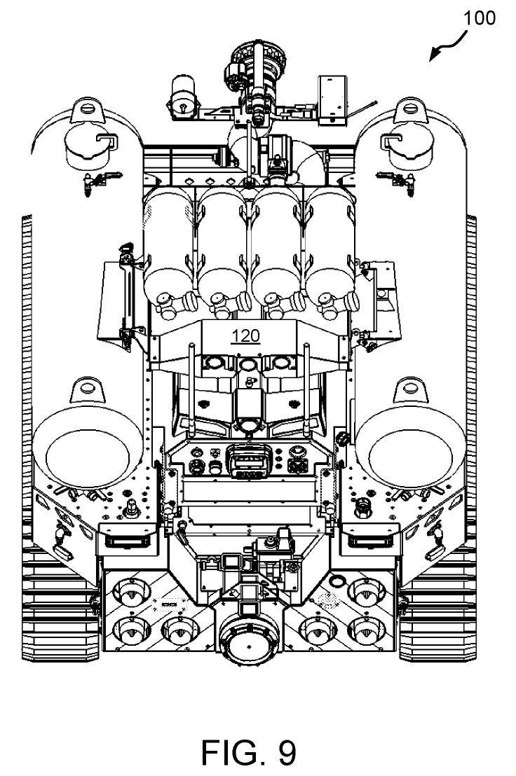

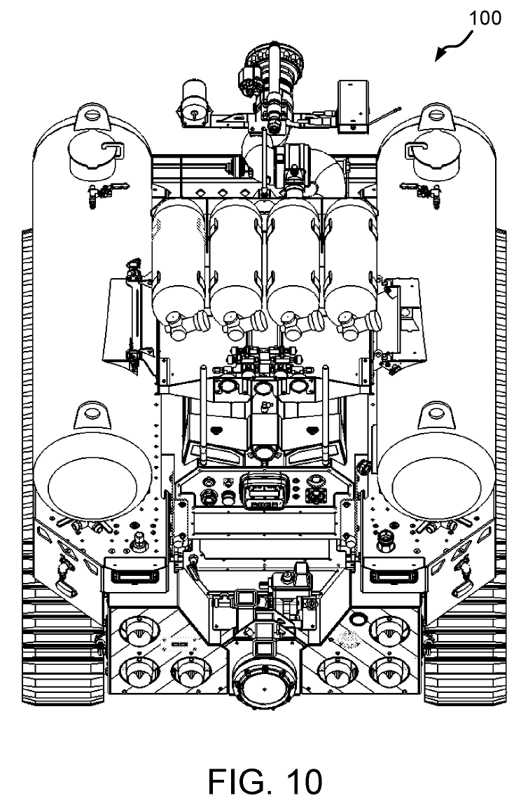

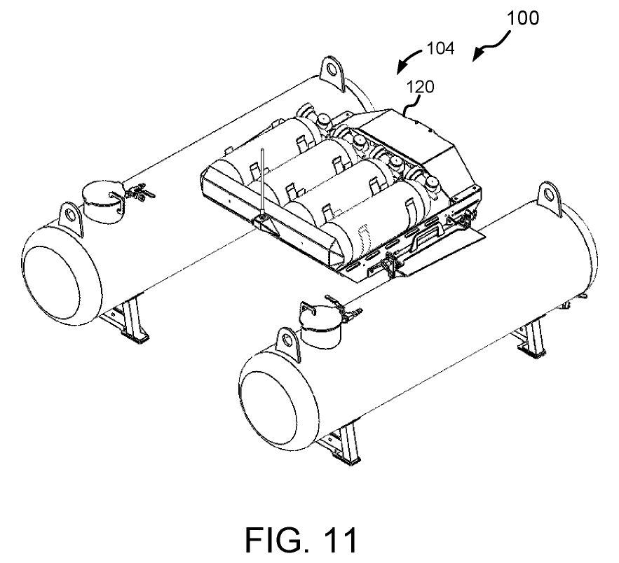

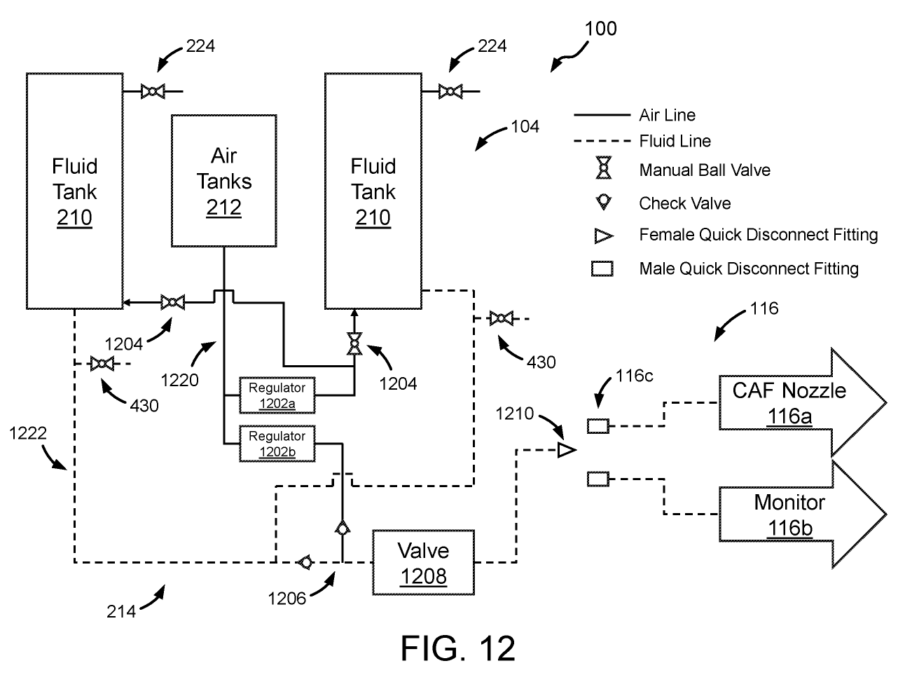

FIGS. 1 through 11 show various views of a robotic foam delivery system 100 in accordance with certain embodiments. As shown, the robotic foam delivery system 100 includes a vehicular robot 102 and a fluid tank assembly 104.

The vehicular robot 102 includes a body 110 (e.g., a chassis, a frame, etc.), a set of engagement members 112, a propulsion system 114, specialized equipment 116, and a controller 118. It should be understood that the vehicular robot 102 has the form factor of a robotic tracked firefighting vehicle by way of example only and that other types of form factors are suitable for use as well such as a quad-style all-terrain vehicle with a set of protective screens, a crane with a set of protective screens, construction equipment, military equipment, other specialized movable equipment, amphibious craft, watercraft, other hybrid craft, and so on which may utilize foam material from a container source.

Further, certain componentry such as the propulsion system 114, the controller 118, etc. are represented by various corresponding reference numerals in FIG. 1. It should be appreciated that some of this componentry may be housed within other componentry and/or somewhat blocked from view by other componentry in FIG. 1. Additionally, as will be explained in greater detail below, certain features are hidden from view in one or more of the figures to highlight certain aspects of the robotic foam delivery system 100.

The body 110 includes a forward end 130 and an aft (rear) end 132. The body 110 offers various mounting locations (e.g., decking areas) that enable equipment such as the fluid tank assembly 104 to be conveniently mounted and accessed. In some arrangements, decking areas of the body 110 horizontally extend over respective engagement members 112 thus providing a platform for equipment as well as protection/shielding to the engagement members 112.

The set of engagement members 112 is constructed and arranged to interact with the environment to move the vehicular robot 102. It should be understood that various types of engagement members 112 are suitable for use (e.g., tracks, tires/wheels, propellers, fans, combinations thereof, and so on) depending on the type of environment or terrain (e.g., a road, dirt, brush, snow, ice, marsh, water, etc.).

The propulsion system 114 is constructed and arranged to control vehicle movement such as drive provided by the set of engagement members 112, speed control, braking, and so on, thus enabling the vehicular robot 102 to effectively maneuver and perform useful work. Along these lines, the propulsion system 114 enables the vehicular robot 102 to move forward, backward, turn, and so on.

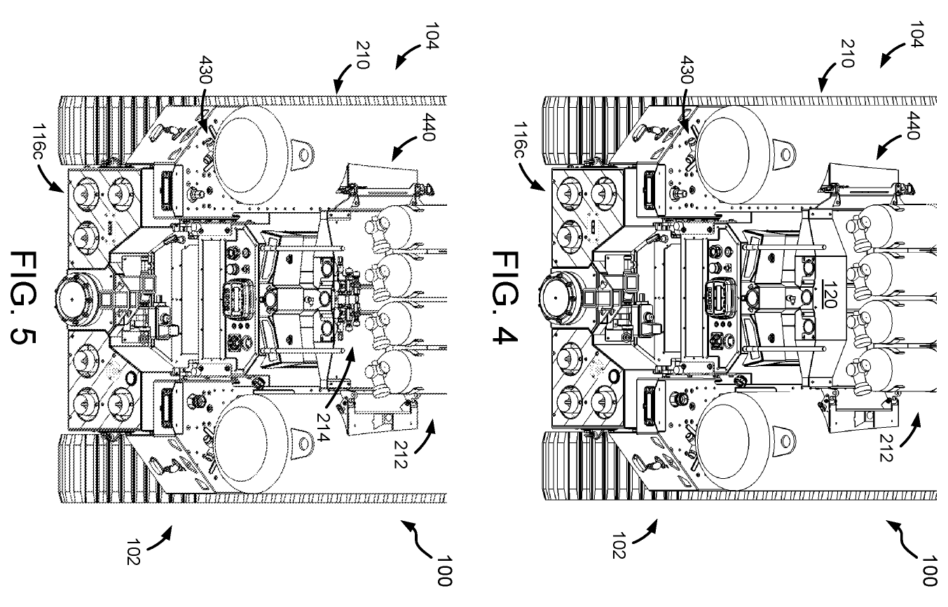

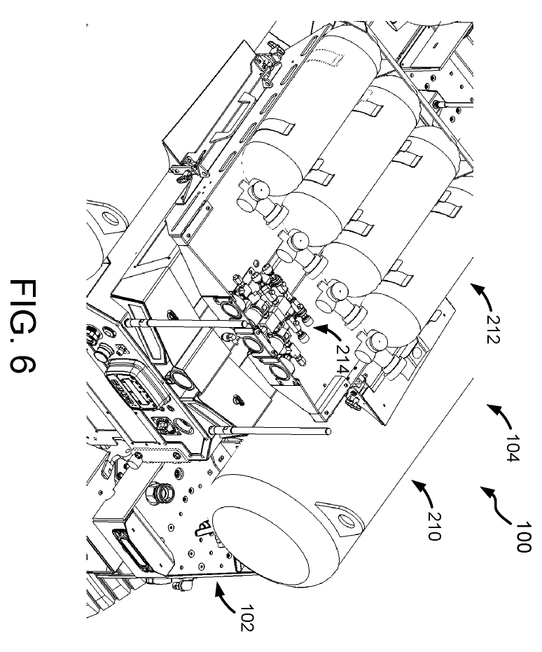

The specialized equipment 116 is constructed and arranged to perform useful work. In the context of a firefighting vehicle, the specialized equipment 116 includes one or more monitor (or nozzle) assemblies capable of spraying a foam–water mixture toward a targeted area. Along these lines, as best shown in FIG. 3, the specialized equipment 116 includes a compressed-air foam (CAF) nozzle assembly 116a, which receives a foam–water mixture from the fluid tank assembly 104 and outputs the foam–water mixture toward a targeted area. The specialized equipment 116 further includes a monitor assembly 116b, which performs foam concentrate induction to generate the foam–water mixture from foam concentrate provided by the fluid tank assembly 104. To perform the foam concentrate induction, the monitor assembly 116b includes an internal mixing chamber that combines the foam concentrate with water to generate the foam–water mixture, which is then output toward the targeted area. For both the CAF nozzle assembly 116a and the monitor assembly 116b, the foam–water mixture may be output at a high rate (e.g., 2,500+/− gallons per minute). Further, as best shown in FIGS. 4 and 5, the specialized equipment 116 includes one or more inlet ports 116c leading to the CAF nozzle assembly 116a and/or the monitor assembly 116b. The inlet ports 116c are constructed and arranged to receive fluid from one or more fluid sources (e.g., a water source, a foam-material source, combinations thereof, etc.), and rout the fluid to other specialized equipment 116 (e.g., the CAF nozzle assembly 116a and/or the monitor assembly 116b).

In some embodiments, the vehicular robot 102 is provisioned with back-to-front piping (or plumbing) that connects to one or more fluid sources (e.g., via the inlet ports 116c that connect to a set of hoses leading to a set of hydrants, the fluid tank assembly 104, etc.). Such piping may extend from the back through the body 110 to the front of the vehicular robot 102 where the specialized equipment 116 is able to deliver a foam–water mixture, e.g., at a rate of up to 2,500 gallons per minute, at a target area.

The controller 118 is constructed and arranged to operate various componentry of the vehicular robot 102 such as the propulsion system 114 and/or the specialized equipment 116. In the context of the firefighting vehicle, the controller 118 may aim or point a nozzle/head of the CAF nozzle assembly 116a and/or the monitor assembly 116b (e.g., via a set of actuators), operate fluid valves, etc. to generate and/or receive a foam–water mixture and spray the foam–water mixture at a targeted area. Additionally, the controller 118 may obtain information from the surrounding environment, manage other resources, and/or operate other equipment to lift, push, communicate with a base station, and so on. For example, in some embodiments, the controller 118 may wirelessly communicate with a remote-control device 140 via communication signals 142 to receive commands and transmit information about the vehicular robot 102. In other embodiments, a physical cable (or “tether”) may be used to transmit the communication signals 142 between the remote device 140 and the vehicular robot 102, e.g., in situations with high levels of radio frequency interference.

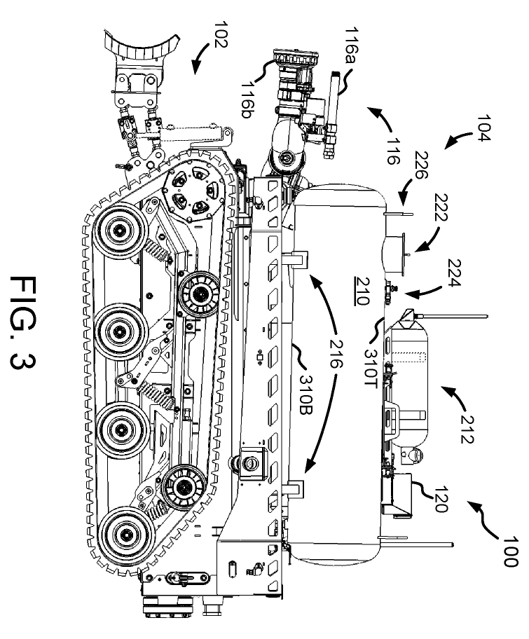

The fluid tank assembly 104 is constructed and arranged to hold firefighting-foam material while mounted on the vehicular robot 102. As will be explained in further detail shortly, the fluid tank assembly 104 alleviates the need to hook up the vehicular robot 102 to a foam-supply truck. Accordingly, the vehicular robot 102 is freer to maneuver towards and/or around a targeted area to spray foam. As best shown in FIG. 2, the fluid tank assembly 104 includes a set of fluid tanks 210, a set of air tanks 212, a control assembly 214, and mounting hardware 216.

The set of fluid tanks (or containers) 210 is constructed and arranged to hold a variety of different firefighting-foam materials, e.g., foam concentrate to be mixed with water, a preprepared foam–water mixture, and so forth. As best shown in FIGS. 4 and 5, the set of fluid tanks 210 includes a set of outlet ports 430 disposed at lower-aft ends of the fluid tanks 210 for discharging firefighting-foam material from the fluid tanks 210. The outlet ports 430 are constructed and arranged to attach to one or more hoses (not shown) leading to a connector or input of the specialized equipment 116 (e.g., the inlet ports 116c leading to the CAF nozzle 116a and/or the monitor assembly 116b). The outlet ports 430 may include an interface in the form of a clamp, a coupler, other type of connector, etc. The outlet ports 430 enable a healthy delivery of foam material to the specialized equipment 116.

In some embodiments, the set of fluid tanks 210 includes various other componentry, such as a set of hatches 222, a set of air vents 224, and a set of lift points 226. As shown in FIG. 3, the set of hatches 222 is disposed on a top portion 310T of one or more of the fluid tanks 210 and is constructed and arranged to allow foam material to enter the set of fluid tanks 210 through the top portion 310T. The set of hatches 222 may define a lip or other shape (e.g., a funnel) to facilitate certain operations such as supporting a cover (or cap), enabling the cover to thread onto and/or from the set of hatches 222, directing flow into the set of fluid tanks 210, and so on.

In some embodiments, the set of hatches 222 defines a diameter which is wider than that of the outlet port 430. Such a feature enables quicker filling of the set of fluid tanks 210 with foam material (e.g., via a bucket, hose, or other supply mechanism). Additionally, the narrower outlet port 430 provides for effective withdrawal of foam material from the set of fluid tanks 210 (e.g., assisted by compressed air from the set of air tanks 212 or by siphoning forces from the specialized equipment 116 on the vehicular robot 102.

The set of air vents 224 is constructed and arranged to selectively permit air to flow into the set of fluid tanks 210 as foam material exits the set of fluid tanks 210 through one or more of the outlet ports 430. Along these lines, the foam material may be extracted from the set of fluid tanks 210 via siphoning action, and air may enter the set of fluid tanks 210 through the set of air vents 224 to displace the removed foam material. Accordingly, a vacuum is less likely to form within the set of fluid tanks 210 that could otherwise hinder removal of the foam material from the set of fluid tanks 210 and perhaps result in tank deformation and/or damage. The set of air vents 224 is further constructed and arranged to selectively block compressed air from exiting the set of fluid tanks 210. Along these lines, the set of fluid tanks 210 may be pressurized via compressed air from the set of air tanks 212, and the set of air vents 224 may be closed to prevent the compressed air from leaving the set of fluid tanks 210.

The lift points 226 are constructed and arranged to enable easy lifting of the fluid tank assembly 104 onto and/or off of the vehicular robot 102. In some arrangements, the lift points 226 include tabs with openings to enable lifting via various equipment (e.g., via a crane, a hoist/pulley, a jig, etc.). Such lift points 226 alleviate the need to carry the fluid tank assembly 104 in a different manner or via other means. Although two lift points on each of the fluid tanks 210 are provided by way of example, the fluid tank assembly 104 may include a different number of lift points 226 (e.g., one, three, four, and so on).

The set of air tanks 212 is constructed and arranged to provide compressed air. Although the term “air” is used herein, it should be appreciated that the set of air tanks 212 may be filled with other compressible fluids, e.g., solely oxygen, solely nitrogen, a combination of gases, and so forth. The fluids in the set of air tanks 212 may be pressurized, e.g., to approximately 4,500 pounds per square inch (psi). As shown in FIGS. 4 and 5, the set of air tanks 212 are arranged on a rack 440 spanning the fluid tanks 210. In this manner, the set of air tanks 212 may be centrally disposed and provide cover for various equipment carried the vehicular robot 102, e.g., the controller 118.

In some embodiments, the set of fluid tanks 210 and/or the set of air tanks 212 include one or more ceramic layers or other protective coatings constructed and arranged to insulate the respective tanks from excessive heat, e.g., when the fluid tank assembly 104 is near a burning object. The one or more ceramic layers may reside as a cover or coating on the inside or the outside of the respective tanks. In some arrangements, ceramic layers are provided on only some sides of the tanks (e.g., forward, aft, top, and outer-side portions of the tanks), as other sides (e.g., bottom and inner side portions) may be able to receive heat shielding from the vehicular robot 102.

The control assembly 214 includes a collection of conduits and valves constructed and arranged to control delivery of foam material from the set of fluid tanks 210. The control assembly 214 is coupled between the set of fluid tanks 210 and the set of air tanks 212 via a set of air pipes (or lines). Additionally, the control assembly 214 is further coupled between the set of fluid tanks 210 and one or more of the inlet ports 116c on the vehicular robot 102 via another set of fluid pipes. It should be appreciated that the set of air pipes and set of fluid pipes are hidden from view in FIGS. 1 through 11 for simplicity but are described in greater detail below in relation to FIG. 12.

The control assembly 214 is constructed and arranged to enter a variety of different configurations to deliver the foam material from the set of fluid tanks 210 to the inlet ports 116c. As will be described in greater detail below, such configurations may include differences in valve actuation, piping connections, and so forth. In a first configuration, the control assembly 214 allows compressed air from the set of air tanks 212 to enter the set of fluid tanks 210 to discharge foam material from the set of fluid tanks 210. In a second configuration, the control assembly 214 inhibits the compressed air from entering the set of fluid tanks 210 and instead allows the specialized equipment 116 to draw the foam material from the set of fluid tanks 210, e.g., by siphoning.

As best shown in FIGS. 1, 4, 7, 9, and 11, at least a portion of the control assembly 214 may be housed below a shroud (cover) 120. In some embodiments, the shroud 120 provides protection to the control assembly 214, e.g., from heat, debris, contaminates, and so forth. The shroud 120 is hidden from view in other figures to highlight certain features of the control assembly 214.

The mounting hardware 216 is constructed and arranged to mount the fluid tank assembly 104 to the body 110 of the vehicular robot 102. In some arrangements, the mounting hardware 106 includes bolts and/or similar types of fasteners. In some arrangements, the mounting hardware 106 includes clamps, latches, combinations thereof, etc. to enable quicker/simpler mounting of the fluid tank assembly 104 onto and/or dismounting of the fluid tank assembly 104 from the vehicular robot 102 (e.g., to enable the fluid tank assembly 104 to be exchanged with other equipment).

In some embodiments, the mounting hardware 216 is further constructed and arranged to further position the fluid tank assembly 104 relative to the vehicular robot 102. Along these lines, the mounting hardware 216 may include a set of support beams (or feet) to support a bottom portion 310B of one or more of the fluid tanks 210 over the body 110 of the vehicular robot 102 (e.g., see FIG. 3). Such one or more positioning members 266 also prevent the bottom partition 310B from outwardly bowing and/or deforming when the tank 210 is filled with foam material. Other types of mounting hardware 216 are suitable for use as well (e.g., scaffolds, rails, welds, brackets, cross members, ribs, etc.).

As best shown in FIG. 3, the mounting hardware 216 positions forward ends of the fluid tanks 210 (e.g., as shown on the left side of FIG. 3) higher than aft ends of the fluid tanks 210 (e.g., as shown on the right side of FIG. 3). In this manner, the fluid tanks 210 slope downward from the forward ends to the aft ends, urging the foam material within the fluid tanks 210 toward the outlet ports 430 (FIGS. 4 and 5) at the aft ends of the fluid tanks 210. Advantageously, by arranging the outlet ports 430 towards the rear end 132 of the vehicular robot 102, the vehicular robot 102 may provide protection to the outlet ports 430 and other equipment from heat, debris, etc. from a forward direction.

During operation, the vehicular robot 102 communicates with the remote device 140 (FIG. 1) to perform a variety of tasks. Along these lines, the vehicular robot 102 and the remote device 140 may communicate via communication signals 142 (FIG. 1), which are transmitted wirelessly and/or over a physical cable (“tether”). It should be appreciated that transmitting the communication signals 142 wirelessly enables the vehicular robot 102 to be more maneuverable, while the physical cable is useful in situations with high levels of radio frequency interference. The tasks performed by the vehicular robot 102 may include sensing a targeted area (e.g., for heat, people, danger, etc.), moving from one location to another, and spraying water and/or foam at the targeted area. That is, a human user operating the remote device 140 may receive information from the vehicular robot 102 and/or remotely control various operations of the robotic foam delivery system 100 from a safe distance. In some arrangements, the remote device 140 may provide the user with a graphical user interface and control logic to enable the user to reliably and robustly utilize the vehicular robot 102 from the remote device 140.

Further, the fluid tank assembly 104 operates to deliver firefighting-foam material from the set of fluid tanks 210 to the specialized equipment 116 on the vehicular robot 102. In delivering the firefighting-foam material, the control assembly 214 of the fluid tank assembly 104 may be placed in a variety of configurations to provide different modes of operation.

For example, when control assembly 214 is in a first configuration, the control assembly 214 enables compressed air from the set of air tanks 212 to enter the set of fluid tanks 210. The resulting increase in pressure within the set of fluid tanks 210 causes the foam material to be discharged from the set of fluid tanks 210. This configuration is particularly beneficial for delivery of a preprepared foam–water mixture, as the compressed air may agitate the foam–water mixture to ensure that the foam–water mixture is fully mixed prior to discharge. Further, as the foam–water mixture is already prepared, there is no need for a hose to be connected between the vehicular robot and a foam supply or water supply while the vehicular robot 102 is remotely guided or while the vehicular robot 102 delivers foam onto a targeted area. That is, the range of the vehicular robot and/or the ability of the vehicular robot to maneuver is not restricted by any foam-supply hose or water-supply hose thus improving the ability of the vehicular robot 102 to approach and address the target area (e.g., the vehicular robot 102 may move closer to and/or maneuver among different locations around the target area to spray the foam mixture without needing to move a foam-supply truck or negotiate with a hose coupled with the foam-supply truck or water supply).

In another example, when control assembly 214 is in a second configuration, the control assembly 214 closes a connection between the set of air tanks 212 and the set of fluid tanks 210, thereby blocking a flow of compressed air from the set of air tanks 212. In this configuration, the control assembly 214 allows the foam material to be drawn from the set of fluid tanks 210, e.g., by siphoning. This configuration is particularly beneficial for delivery of a foam concentrate, which is mixed with water from a separate water supply to create a foam–water mixture. Along these lines, in some embodiments, the foam concentrate is delivered to the monitor assembly 116b, which provides a fluid junction for the water and the foam concentrate. As the water passes through the fluid junction, the flow of water generates a suction (siphoning) force that draws in the foam concentrate. In this manner, the foam concentrate may mix with the water to create the foam–water mixture. Advantageously, providing foam concentrate enables the creation of a significantly large amount of the foam–water mixture during operation. In some embodiments, the foam concentrate is mixed with water at an approximately 0.5:100 to 6:100 ratio. As a result, the vehicular robot 102 may operate for a significantly long time before the fluid tank assembly 104 needs to be refilled.

It should be appreciated that the fluid tank assembly 104 may be set to whichever configuration best suits the needs of a given firefighting mission. For example, if a separate water supply is unavailable, the fluid tank assembly 104 may be set to the first configuration and filled with the preprepared foam–water mixture. In this manner, no separate water supply is needed. However, if a separate water supply is available, the robotic fluid tank assembly 104 may be set to the second configuration and filled with foam concentrate that is mixed with water from the water supply during discharge. As a result, a significantly amount of the foam–water mixture may be created, enabling the vehicular robot 102 to operate for long periods of time before refilling, if at all. Further details will now be provided with reference to FIG. 12.

FIG. 12 shows a block diagram of the robotic foam delivery assembly 100 in accordance with certain embodiments. It should be understood that certain componentry such as the set of fluid tanks 210, the set of air tanks 212, etc. are represented by various corresponding reference numerals in FIGS. 1-11. Further, as shown in FIG. 12, the control assembly 214 includes air-pressure regulators 1202a and 1202b (collectively, air-pressure regulators 1202), a set of compressed-air valves 1204, and a fluid junction 1206, a control valve 1208, a connector (or fitting) 1210. These features are disposed along a set of air pipes 1220 (as shown as solid lines between other features in FIG. 12) and/or a set of fluid pipes 1222 (as shown as dashed lines in FIG. 12).

The air-pressure regulators 1202 are constructed and arranged to regulate the pressure of the compressed air from the set of air tanks 212. For example, the air-pressure regulators 1202 may reduce the pressure of the compressed air (e.g., from 4,500 psi to less than 200 psi). The first air-pressure regulator 1202a is coupled between the set of air tanks 212 and the set of fluid tanks 210. The second air-pressure regulator 1202b is coupled between the set of air tanks 212 and the fluid junction 1208.

The set of compressed-air valves 1204 is disposed between the set of air tanks 212 and the set of fluid tanks 210. The set of compressed-air valves 1204 is constructed and arranged to selectively permit compressed air from the set of air tanks 212 to enter the set of fluid tanks 210. In a first configuration, the set of compressed-air valves 1204 is opened to allow the compressed air to enter the set of fluid tanks 210. In a second configuration, the set of compressed-air valves 1204 is closed to block the compressed air from entering the set of fluid tanks 210. In some embodiments, the set of compressed-air valves 1204 includes ball valves that may be manually or electronically actuated.

The fluid junction 1206 is constructed and arranged to merge a first fluid flow of the foam material from the set of fluid tanks 210 and a second fluid flow of the compressed air from the set of air tanks 212. The fluid junction 1206 includes a set of check valves constructed and arranged to prevent a backflow of foam material or air into the set of fluid tanks 210 and the set of air tanks 212.

The control valve 1208 is constructed and arranged to control the flow of foam material from the set of fluid tanks 210 for use by the specialized equipment 116 (FIG. 1). For example, in the context of a firefighting vehicle, the control valve 1208 may remain closed while the firefighting vehicle moves toward a burning object or structure. The control valve 1208 may then open to allow foam material to exit from out of the set of fluid tanks 210 to a monitor assembly for spraying foam onto the burning object or structure. It should be understood that the control valve 1208 may be located between the output ports 430 and a hose. Alternatively, the control valve 220 may be located at an opposite end of the hose or even along the hose. In some embodiments, the control valve 1208 is electronically actuated, e.g., by remote control via remote control device 140 (FIG. 1). In this manner, a user may operate the robotic foam delivery system 100 from a safe distance to deliver foam material to the specialized equipment 116 on the vehicular robot 102.

The connector 1210 is constructed and arranged to couple with the inlet ports 116c to direct foam material from the set of fluid tanks 210. In a first configuration, the connector 1210 directs the foam material to a first one of the inlet ports 116c, e.g., the inlet port 116c leading to the CAF nozzle assembly 116a (FIG. 3). In a second configuration, the connector 1210 directs the foam material to the second one of the inlet ports 116c, e.g., the inlet port 116c leading to the monitor assembly 116b (FIG. 3). In this manner, the connector 1210 directs foam material from the set of fluid tanks 210 to an appropriate one of the inlet ports 116c as needed for a given configuration. In some embodiments, the connector 1210 may be manually attached to one of the inlet ports 116c when entering a particular configuration. Alternatively or in addition, the connector 1210 may be coupled to multiple of the inlet ports 116c simultaneously, and include switching componentry to redirect the foam material to individual ones of the inlet ports 116c.

The set of air pipes 1220 are constructed and arranged to carry compressed air from the set of air tanks 212 to the set of fluid tanks 210, and from the set of air tanks 212 to the fluid junction 1206. Similarly, the set of fluid lines 1222 are constructed and arranged to carry foam material from the set of fluid tanks 210 to the connector 1210 for discharge.

During operation, the control assembly 214 may be placed in a first configuration. In the first configuration, the set of air tanks 212 provides compressed air to the set of fluid tanks 210 and the fluid junction 1206 via the regulators 1202. The regulators 1202 decrease a pressure of compressed air (e.g., from 4,500 psi to less than 200 psi) before the compressed air enters the set of fluid tanks 210 and the fluid junction 1202.

Based on the compressed air provided to the set of fluid tanks 210, the firefighting-foam material within the set of fluid tanks 210 may be discharged from the set of the fluid tanks 210 under pressure. In some embodiments, the compressed air is provided by only a portion of the set of air tanks 212 at a given time, e.g., two out of four of the air tanks 212. In this manner, some of the air tanks 212 may be rationed for later use, e.g., during longer firefighting missions. Additionally, in some embodiments, the compressed air is directed to only a portion of the set of fluid tanks 210 at a time, e.g., the compressed air may be directed to a first one of the fluid tanks 210 before a second one of the fluid tanks 210.

The compressed air provided to the fluid junction 1206 serves at least two functions. First, the compressed air creates a Venturi effect which assists in drawing the foam material from the set of fluid tanks 210. Second, the compressed air agitates the foam material within the fluid junction 1206, which assists in ensuring the foam material (e.g., a combination of foam concentrate and water) is thoroughly mixed before discharge.

When delivering the foam material, the control valve 1208 is actuated to enable the foam material to flow from the fluid junction 1206 to the specialized equipment 116 on the vehicular robot 102. In the first configuration, the connector 1210 is coupled with one of the inlet ports 116c leading to the CAF nozzle assembly 116a. In this manner, the foam material may be delivered to the CAF nozzle assembly 116a under pressure and discharged from the CAF nozzle assembly 116a onto a targeted area.

Further during operation, the control assembly 214 may be placed in a second configuration that is different from the first configuration. In the second configuration, the set of air tanks 212 is closed to block a flow of compressed air to the set of fluid tanks 210. In this manner, the set of fluid tanks 210 may provide firefighting-foam material without pressure from the compressed air, e.g., by gravity or siphoning. In some embodiments, the set of air vents 224 are opened to allow air to enter the fluid tanks 210 when in the second configuration.

Similar to the first configuration, the control valve 1208 is actuated to enable the foam material to flow from the fluid junction 1206 to the specialized equipment 116. However, in the second configuration, the connector 1210 is coupled with one of the inlet ports 116c leading to the monitor assembly 116b. The monitor assembly 116b may be connected with a separate water supply (e.g., a fire hydrant), which provides a flow water that interests a fluid path for the foam material (e.g., foam concentrate) within the monitor assembly 116a. The flow of water creates siphoning forces that draw the foam material into the flow of water to create a foam–water mixture. The monitor assembly 116b then discharges the foam–water mixture onto a targeted area.

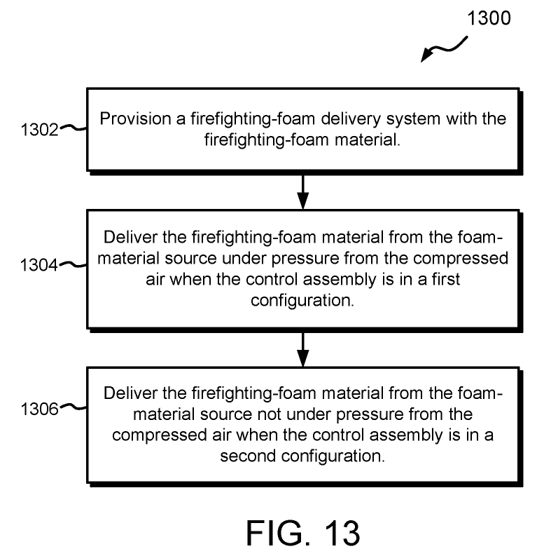

Advantageously, the variety of configurations enable the robotic foam delivery system 100 to deliver foam material to specialized equipment 116 having different modes of operation. For example, the CAF nozzle assembly 116a may be configured to receive foam material (e.g., a foam–water mixture) under pressure from compressed air. In contrast, the monitor assembly 116a may be configured to receive foam material (e.g., foam concentrate) not under pressure from compressed air, which mixes with water under pressure. By switching between different configurations, the robotic foam delivery system 100 may support these different modes of operation. Further details will now be provided with reference to FIG. 13.

FIG. 13 is a flowchart showing a method 1300 for providing firefighting-foam material in accordance with certain embodiments.

At 1302, the robotic foam delivery system 100 is provisioned with firefighting-foam material. The robotic foam delivery system 100 includes a foam-material source (e.g., a set of fluid tanks 210) constructed and arranged to contain the firefighting-foam material. The robotic foam delivery system 100 further includes a compressed-air source (e.g., the set of air tanks 212) constructed and arranged to provide compressed air. The robotic foam delivery system 100 still further includes a control assembly 214 coupled with the foam-material source and the compressed-air source. In some embodiments, the robotic foam delivery system 100 is provisioned with firefighting-foam material by filling the foam-material source with a foam–water mixture. In other embodiments, the robotic foam delivery system 100 is provisioned with firefighting-foam material by filling the foam-material source with foam concentrate.

At 1304, the robotic foam delivery system 100 delivers the firefighting-foam material from the foam-material source under pressure from the compressed air when the control assembly is in a first configuration. In some embodiments, the control assembly 214 enables the compressed air to flow from the compressed-air source to the foam-material source. In this manner, the compressed air discharge the foam material from the foam-material source.

At 1306, the robotic foam delivery system 100 delivers the firefighting-foam material from the foam-material source not under pressure from the compressed air when the control assembly is in a second configuration. In some embodiments, the control assembly 214 blocks the compressed air from flowing from the compressed-air source into the foam-material source. In this manner, the control assembly 214 enables the foam material to be drawn out of the foam-material source, e.g., by gravity or siphoning.

As described above, improved techniques are directed to a firefighting-foam delivery system switches between different configurations for delivering firefighting-foam material. In one configuration, the firefighting-foam delivery system feeds compressed air from a compressed-air source into a foam-material source to discharge firefighting-foam material from the foam-material source. In another configuration, the firefighting-foam delivery system blocks the compressed air from entering the foam-material source and instead enables the firefighting-foam material to be drawn from foam-material source, e.g., by siphoning. By providing different configurations, the firefighting-foam delivery system may deliver the firefighting-foam material in different ways, increasing compatibility with a variety of different equipment and/or foam materials.

While various embodiments of the present disclosure have been particularly shown and described, it will be understood by those skilled in the art that various changes in form and details may be made therein without departing from the spirit and scope of the present disclosure as defined by the appended claims.

For example, although the set of air tanks 212 is described above, it should be appreciated that compressed air may be provided in other manners without departing from the scope of the present disclosure. For example, in some embodiments, an air compressor may be used to provide compressed air.

In accordance with certain embodiments, specialized equipment such as a foam-induction monitor is able to obtain foam material from a foam material tank/delivery system. Such a foam material tank/delivery system is well suited for fluid transportation and/or firefighting and, in particular, to robotic firefighting attachments.

Conventional approaches may only involve a vehicle that is able to spray foam when the vehicle is hooked to a truck pumping foam. Unfortunately, such use of a truck to pump foam is a significant resource requirement and can impede operation of the robot.

However, with the improved techniques disclosed herein, a robotic vehicle is able to carry its own foam concentrate and foam mixture. Accordingly, the robotic vehicle is now able to spray foam without a foam capable truck.

In some embodiments, the foam delivery system includes fluid tanks that are 50 gallons each and are capable of being mounted on multiple robot vehicle platforms (or other robot configurations). Other capacities such as those within a range of 30 gallons to 200 gallons are suitable as well (40 gallons, 60 gallons, 75 gallons, etc.).

In some embodiments, the tanks feature a sloped design that leads to a siphon/suction port, ensuring full use of the water–foam mixture or foam concentrate. A large fill port on the top of the tank allows for easy fill from a 5-gallon pail or a transfer pump from a larger drum and/or water supply.

In some embodiments, large vents on the tops of the tanks allow for sufficient airflow to prevent deformation or destruction of the tanks when foam concentrate is siphoned out. Further, the siphon port has a valve (manual or electric) that allows for choosing to deliver foam material or to not.

In some embodiments, the foam delivery system includes valves to swap between a compressed-air foam (CAF) configuration and a non-CAF (siphon and/or suction) configuration. The CAF configuration utilizes compressed-air tanks that, with the flip of a valve, forces compressed air into the water/fluid tanks and force the mixture out of a nozzle.

In some embodiments, mounting points on the vehicle fore and aft enable the fluid tanks to be secured via two mounting feet on each tank. A sloped design of the fluid tank allows for a smaller sump area allowing for more of the foam concentrate or foam–water mixture to be used even in off-angled situations. Further, a tray is attached between two fluid tanks. The tray is used to carry the air tanks for the system. Fill caps on the fluid tanks are removed by operator and foam concentrate or a foam–water mixture is poured into the tanks via small pails and/or via a large drum or water source. Once filled, a valve is either manually or remotely opened, and the vehicular robot is sent in to fight a fire.

If the fluid tanks are filled with foam concentrate, the foam concentrate may flow from the valve down to a monitor via a hose and is induced into the water stream via a Venturi port that exists on the monitor. If the tanks are filled with a foam–water mixture, the system may be swapped to the CAF arrangement. In the CAF arrangement, the air tanks force the foam–water mixture out an independent nozzle instead of the Venturi port on the monitor.

The system can be swapped between the two configurations by closing and/or opening some valves and swapping the tank discharge line from the monitor to an independent nozzle using a quick-disconnect coupling. Additional details of an example CAF configuration and an example non-CAF configuration will now be described.

### Example CAF configuration

In the example CAF configuration, the fluid tanks are filled with a foam–water mixture, e.g., a mixture including 1-2% foam concentrate. The foam concentrate may be aqueous film-forming foam (AFFF) or a similar alternative.

The fluid tanks may include bleeder valves to release pressure from the fluid tanks after use. Further, the fluid tanks may include drain valves may be provided in the fluid outlet lines to drain any fluid from the fluid tanks after use.

The air tanks may be filled with compressed air to approximately 4500 psi. Multiple air tanks may be plumbed together so there is one air line from them. The air line leads to the fluid tanks and to a fluid line downstream from the fluid tanks. Before the air line connects with the fluid line downstream from the fluid tanks, there are check valves which prevent fluid from back-feeding to the air line and air from back-feeding the fluid line.

During example operation, the fluid and air move through the system as follows:

Air tanks are opened individually or all together using the valves that are installed with the tanks. In some embodiments, two of the air tanks are opened for one fluid tank or all four of the air tanks for both fluid tanks. It should be appreciated that this system could be expanded beyond the four air tanks and two fluid tanks.

Air is then routed to two separate regulators. A first regulator reduces the pressure (e.g., down to approximately between 100 and 200 psi) and supplies air to the fluid tanks. The purpose of this air line is to pressurize the fluid tanks and force water out of the outlet. A second regulator reduces the pressure (e.g., down to approximately between 100 and 200 psi) and supplies air to the fluid line down the system. The purpose of this air line from the second regulator serves two purposes: One purpose is to create a Venturi effect in the fluid line later in the system to assist with pulling the fluid through the system. The second purpose is to stir up the water–foam mixture to ensure that it is mixed properly.

The air from the first regulator is then split to go to each fluid tank. Once the air line is split there is a manual ball valve for each fluid tank. The user can choose to open one or both valves depending on the capacity of foam water mixture required. Once the valves are opened, the air will pressurize the fluid tanks and force fluid into the fluid lines.

The air from the second regulator and the fluid from the fluid tanks are then fed through the corresponding air and fluid lines. These are merged just before the primary delivery valve that is remotely operated from the vehicle controller.

After the primary delivery valve, there is a fluid line to route the foam–water mixture to a nozzle. On the end of this line, there is a female quick-disconnect fitting that can either connect to the CAF nozzle or a monitor. For the CAF configuration, the line is connected to a male quick-disconnect fitting on the CAF nozzle.

At this point, the system is primed and ready to be operated in whatever scenario the vehicle is being used. Once the user remotely opens the primary delivery valve, the foam–water mixture will be sprayed from the CAF nozzle to the desired area. To disarm the system, the same procedure may be performed in reverse. There are bleeder valves on each fluid tank to open to relieve pressure once the system has been disarmed. If there is remaining fluid that needs to be drained from the tanks, then there are additional valves that can be opened to drain fluid.

### Example non-CAF configuration

In the example non-CAF configuration, the fluid tanks are filled with a foam concentrate only (not pre-mixed with water). The foam concentrate may be aqueous film-forming foam (AFFF) or a similar alternative.

The fluid tanks may include drain valves may be provided in the fluid outlet lines to drain any fluid from the fluid tanks after use. There are check valves just before the primary delivery valve. For the non-CAF configuration, these prevent foam concentrate from back-feeding into the air line. As there is no air pressure in the non-CAF configuration, there is no worry about air back-feeding the fluid lines.

During operation the fluid will move through the system as follows:

Before the system is used, the air tanks are off and the air lines are closed.

Once the fluid tanks are filled with the foam concentrate, the foam concentrate from the fluid tanks is gravity feed through the fluid lines to prime them up to the primary delivery valve that is remotely operated from the vehicle controller.

As there will be a suction on the fluid tanks, valves on the fluid tanks are opened to enable ambient air into the tanks. In this manner, the foam concentrate can freely flow out of the bottom of the tanks. These valves may be the same valves used to bleed the pressure from the fluid tanks for the CAF configuration.

After the primary delivery valve, there is a fluid line to route the foam concentrate to a monitor. On the end of this line, there is a female quick disconnect fitting that can either connect to the CAF nozzle or the monitor. For the non-CAF configuration, the line is connected to a male quick-disconnect fitting on the monitor.

At this point, the foam delivery system is primed and ready to be operated. Once a monitor valve is opened from the vehicle controller and water is flowing through the monitor, there will be a Venturi suction force on the fluid line of the foam delivery system. When the primary delivery valve in the foam delivery system is opened, foam concentrate will be pulled to the monitor. Contained within the monitor is a mixing chamber that mixes the foam concentrate with water in the monitor before it is sprayed to the desired area. To disarm the system, the primary delivery valve on the foam delivery system may be closed. As a result, the supply of foam concentrate is blocked so that only water passes through the monitor until the monitor valve is shut. If there is remaining foam concentrate that needs to be drained from the fluid tanks, then there are valves on the fluid tanks that can be opened to drain fluid.

After use, due to the caustic nature of some foam concentrates, the system may be cleaned out. In some arrangements, an integrated flush port allows a generic garden hose to be hooked up to allow drainage to a desired location while the tank is washed out.

In certain use-case implementations, the vehicle may serve as a firefighting vehicle. Other use cases are suitable as well such as vehicles for chemical treatment, riot-handling vehicles, and so on.

In the context of a firefighting robot, the vehicle is specially adapted to spray foam, water and/or other fluids on fires. In some arrangements, the robot vehicle is significantly smaller than a firetruck. Such a firefighting robot is maneuverable and able to aim water accurately at desired targets. The Thermite robot available from Howe & Howe, Incorporated of Waterboro, ME, is a remote controlled, tracked vehicle with a remotely aimed nozzle (monitor) that can discharge fluid in high capacity (e.g., 1,500 gallons of water per minute or more). The Thermite has the ability to withstand environments that are too hazardous for human personnel. Such a robot is suitable for use by various improvements disclosed herein.

As used within this document, the words “comprising,” “including,” “containing,” and “having” may be intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should not be interpreted as meaning “based exclusively on” but rather “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the disclosure. Such modifications and enhancements are intended to belong to various embodiments of the disclosure.

What is claimed is:

1. A firefighting-foam delivery system, comprising:
a foam-material source constructed and arranged to contain firefighting-foam material;
a compressed-air source constructed and arranged to provide compressed air; and
a control assembly coupled with the foam-material source and the compressed-air source, the control assembly being constructed and arranged to deliver the firefighting-foam material from the foam-material source under pressure from the compressed air when the control assembly is in a first configuration, and deliver the firefighting-foam material from the foam-material source not under pressure from the compressed air when the control assembly is in a second configuration.

2. The firefighting-foam delivery system of claim 1, wherein the foam-material source includes a set of containers constructed and arranged to hold the firefighting-foam material; and
wherein the firefighting-foam delivery system further comprises mounting hardware constructed and arranged to couple the set of containers to a firefighting vehicle.

3. The firefighting-foam delivery system of claim 2, wherein the control assembly is further constructed and arranged to selectively permit the compressed air provided by the compressed-air source to enter the set of containers to pressurize the firefighting-foam material held within the set of containers.

4. The firefighting-foam delivery system of claim 2, wherein the foam-material source further includes a set of vents constructed and arranged to block air within the set of containers from exiting the set of containers when the control assembly is in the first configuration, and channel air that is initially outside the firefighting-foam delivery system into the set of containers when the control assembly is in the second configuration.

5. The firefighting-foam delivery system of claim 2, wherein the control assembly further includes a connector coupled between the set of containers and equipment mounted to the firefighting vehicle, the equipment mounted to the firefighting vehicle having a first inlet port and a second inlet port, the connector being constructed and arranged to direct the firefighting-foam material to the first inlet port when the control assembly is in the first configuration, and direct the firefighting-foam material to the second inlet port in place of the first inlet port when the control assembly is in the second configuration.

6. The firefighting-foam delivery system of claim 2, wherein the set of containers includes a container having:
a bottom that includes a first end portion and a second end portion opposite the first end portion; and
an outlet port disposed at the second end portion; and
wherein the mounting hardware is further constructed and arranged to position the first end portion higher than the second end portion to urge firefighting-foam material within the container towards the outlet port.

7. The firefighting-foam delivery system of claim 6, wherein the mounting hardware is further constructed and arranged to mount the second end portion closer to an aft end of the firefighting vehicle than the first end portion.

8. The firefighting-foam delivery system of claim 2, wherein the set of containers includes a first container and a second container; and
wherein the firefighting-foam delivery system further comprises a rack spanning the first container and the second container, the rack being constructed and arranged to support the compressed-air source.

9. The firefighting-foam delivery system of claim 1, wherein the compressed-air source includes a set of air tanks constructed and arranged to contain the compressed air.

10. A vehicular robot, comprising:
a vehicle body;
a set of ground-engaging members coupled with the vehicle body; and
a firefighting-foam delivery system, including:
a foam-material source constructed and arranged to contain firefighting-foam material;
a compressed-air source constructed and arranged to provide compressed air; and
a control assembly coupled with the foam-material source and the compressed-air source, the control assembly being constructed and arranged to deliver the firefighting-foam material from the foam-material source under pressure from the compressed air when the control assembly is in a first configuration, and deliver the firefighting-foam material from the foam-material source not under pressure from the compressed air when the control assembly is in a second configuration.

11. The vehicular robot of claim 10, further comprising:
a compressed-air foam (CAF) nozzle assembly constructed and arranged to receive the firefighting-foam material from the firefighting-foam delivery system when the control assembly is in the first configuration; and
a monitor assembly constructed and arranged to receive the firefighting-foam material from the firefighting-foam delivery system when the control assembly is in the second configuration.

12. The vehicular robot of claim 10, wherein the foam-material source includes a set of containers constructed and arranged to hold the firefighting-foam material; and
wherein the firefighting-foam delivery system further includes mounting hardware constructed and arranged to couple the set of containers to the vehicular robot.

13. The vehicular robot of claim 12, wherein the control assembly is further constructed and arranged to selectively permit the compressed air provided by the compressed-air source to enter the set of containers to pressurize the firefighting-foam material held within the set of containers.

14. The vehicular robot of claim 12, wherein the foam-material source further includes a set of ports constructed and arranged to block air within the set of containers from exiting the set of containers when the control assembly is in the first configuration, and channel air that is initially outside the firefighting-foam delivery system into the set of containers when the control assembly is in the second configuration.

15. The vehicular robot of claim 12, further comprising:
a routing assembly coupled with the vehicle body, the routing assembly having a first inlet port and a second inlet port;
wherein the control assembly further includes a connector coupled between the set of containers and the routing assembly, the connector being constructed and arranged to direct the firefighting-foam material to the first inlet port when the control assembly is in the first configuration, and direct the firefighting-foam material to the second inlet port in place of the first inlet port when the control assembly is in the second configuration.

16. The vehicular robot of claim 12, wherein the set of containers includes a container having:
a bottom that includes a first end portion and a second end portion opposite the first end portion; and
an outlet port disposed at the second end portion; and
wherein the mounting hardware is further constructed and arranged to position the first end portion higher than the second end portion to urge firefighting-foam material within the container towards the outlet port.

17. The vehicular robot of claim 16, wherein the mounting hardware is further constructed and arranged to mount the second end portion closer to an aft end of the vehicular robot than the first end portion.

18. The vehicular robot of claim 12, wherein the set of containers includes a first container and a second container; and
wherein the firefighting-foam delivery system further comprises a rack spanning the first container and the second container, the rack being constructed and arranged to support the compressed-air source.

19. The vehicular robot of claim 10, wherein the compressed-air source includes a set of air tanks constructed and arranged to contain the compressed air.

20. A method of providing firefighting-foam material, comprising:
provisioning a firefighting-foam delivery system with the firefighting-foam material, the firefighting-foam delivery system including:
a foam-material source constructed and arranged to contain the firefighting-foam material,
a compressed-air source constructed and arranged to provide compressed air, and
a control assembly coupled with the foam-material source and the compressed-air source;
delivering the firefighting-foam material from the foam-material source under pressure from the compressed air when the control assembly is in a first configuration; and
delivering the firefighting-foam material from the foam-material source not under pressure from the compressed air when the control assembly is in a second configuration.
